(19) United States
(12) Patent Application Publication
(10) Pub. No.: US 2007/0073823 A1
(43) Pub. Date: Mar. 29, 2007

(54) Method and apparatus to secure and retrieve instant messages

(75) Inventors: Gabriel Aaron Cohen, Raleigh, NC (US); Patrick Herbert Cox JR., Raleigh, NC (US); Ronald Eugene Craig, Pittsboro, NC (US); Thomas Richard Haynes, Apex, NC (US); Gerald Laverte Mitchell JR., Raleigh, NC (US); Mohamad R. Salahshoor, Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/239,522

(22) Filed: Sep. 29, 2005

(51) Int. Cl. G06F 15/16

(52) U.S. Cl. 709/207

(57) ABSTRACT

A computer implemented method, apparatus, and computer usable code for managing instant messages. An instant message is received at a client. A set of parameters in the instant message is identified. The instant message on a display in the client is presented, and the instant message is removed from the display after a period of time defined by the set of parameters.

### BACKGROUND OF THE INVENTION

1. Field of the Invention

The present invention relates generally to an improved data processing system and in particular to a method and apparatus for processing and displaying messages. Still more particularly, the present invention relates to a computer implemented method, apparatus, and computer-useable code for securing and retrieving instant messages.

2. Description of the Related Art

Instant messaging is an online chat medium, allowing users to communicate with each other and to collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available. Millions of users communicate using instant messaging systems every day. With instant messaging becoming an important part of both personal and business communications, functionality and usability enhancements are important to the continued success of this type of communication tool. Both in business and personal use, users often find themselves sending and receiving sensitive information through an instant message channel. Currently, the sender of such information has no control over the usage of a sensitive message or any message once the message has been sent. Instant messages may be copied and pasted into a document by the recipient either intentionally or accidentally against the wishes of the sender. Additionally, these messages may be sent to an unintended and open computer display that may be read by any observer.

### BRIEF SUMMARY OF THE INVENTION

The present invention provides a computer implemented method, apparatus, and computer usable code for managing instant messages. An instant message is received at a client. A set of parameters in the instant message is identified. The instant message on a display in the client is presented, and the instant message is removed from the display after a period of time defined by the set of parameters.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a diagram illustrating components in an instant messaging system in accordance with an illustrative embodiment of the present invention;

FIG. 4 is a diagram illustrating an instant messaging client in accordance with a preferred embodiment of the present invention;

FIGS. 5A-5D are diagrams illustrating chat windows in accordance with illustrative embodiments of the present invention;

FIG. 6 is an illustration of a chat window in accordance with an illustrative embodiment of the present invention;

FIG. 7 is a diagram illustrating an alternative example of a sent message in accordance with an illustrative embodiment of the present invention;

FIG. 8 is a diagram illustrating a dialog used to retrieve self-destructed messages in accordance with an illustrative embodiment of the present invention;

FIG. 9 is a diagram illustrating a dialog for retrieving self-destructed messages in accordance with an illustrative embodiment of the present invention;

FIG. 10 is a diagram illustrating a window used for retrieving self-destructed messages in accordance with an illustrative embodiment of the present invention;

FIG. 11 is a diagram illustrating a window used to retrieve self-destructed messages in accordance with an illustrative embodiment of the present invention;

FIG. 12 is a flowchart of a process for sending a self-destructing message in accordance with an illustrative embodiment of the present invention;

FIG. 13 is a flowchart of the process for handling messages in accordance with an illustrative embodiment of the present invention;

FIG. 14 is a flowchart illustrating a process for displaying a self-destructing message in accordance with an illustrative embodiment of the present invention;

FIG. 15 is a flowchart of a process for self-destructing a message in accordance with an illustrative embodiment of the present invention;

FIG. 16 is a flowchart of a process for self-destructing a message in accordance with an illustrative embodiment of the present invention;

FIG. 17 is a flowchart of a process for retrieving or reconstructing a self-destructed message in accordance with an illustrative embodiment of the present invention;

FIG. 18 is a diagram illustrating how options for handling a message may be included in an instant message in accordance with an illustrative example; and

FIG. 19 is another example as to how options may be included in a message in accordance with an illustrative example.

### DETAILED DESCRIPTION OF THE INVENTION

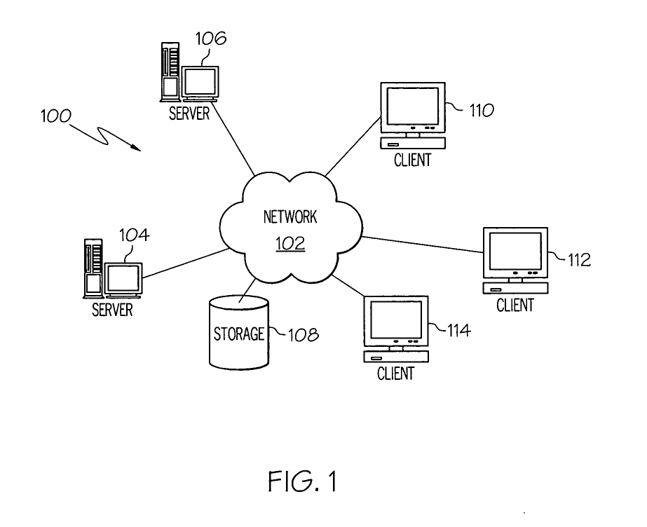

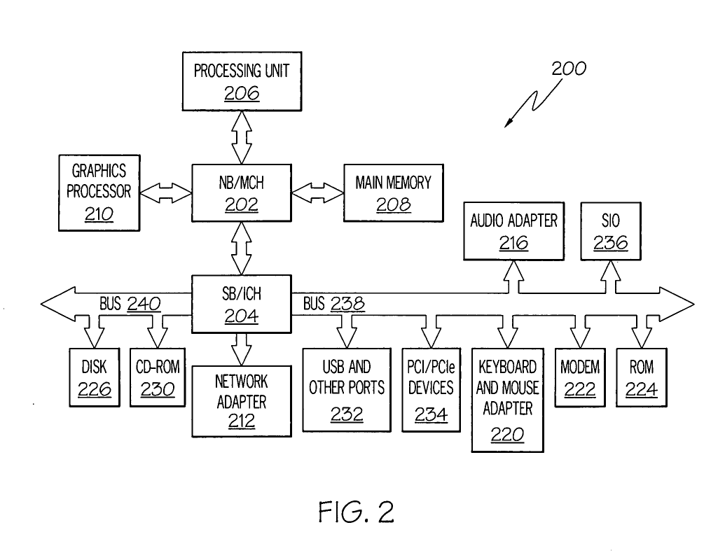

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer usable code for a sender of an instant message to cause the message to self-destruct at the end of some specific time interval. Messages in a chat session are not all sensitive, and typically messages should not persist for an extended amount of time. As a result, the illustrative examples involve the sender indicating that a message should be self-destructed or presented only for a limited amount of time on a message by message basis. Depending upon the implementation, an entire chat session may be designated for this type of handling.

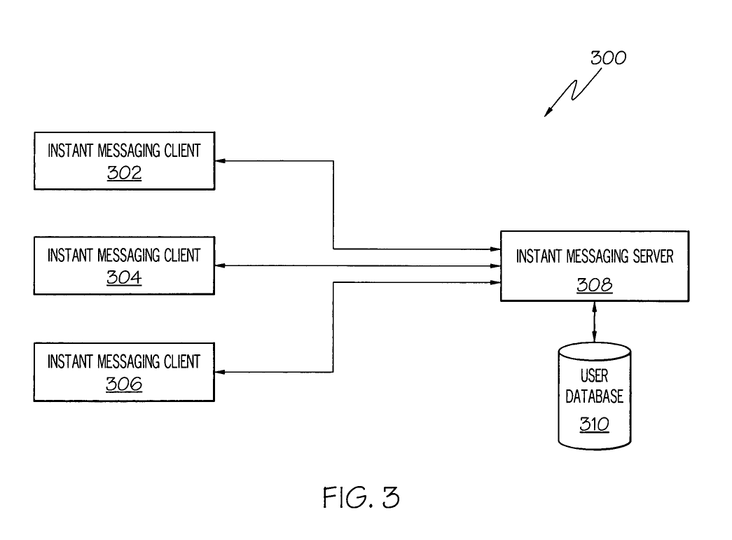

Turning now to FIG. 3, a diagram illustrating components in and instant messaging system is depicted in accordance with an illustrative embodiment of the present invention. In these examples, instant messaging system 300 contains instant messaging clients 302, 304, and 306. These instant messaging clients are implemented using instant messaging applications. These clients exchange messages with each other through instant messaging server 308. The user at instant messaging client 302 may send or exchange messages with other users at instant messaging clients 304 and 306. The instant messaging clients may be executing on a data processing system, such as data processing system 200 in FIG. 2. The exchange of messages in these examples is facilitated through instant messaging server process 308. This process allows users to find other users within instant messaging system 300 as well as aid in the exchange of messages between the different users.

Depending upon the particular instant messaging system, instant messaging server process 308 may only be involved in providing an indication of when particular users are online and for establishing initial contacts, while users contacting other users already on a buddy list may contact those users directly after seeing that a particular user is online. Instant messaging server process 308 may be located on a server, such as data processing system 200 in FIG. 2.

In these illustrative examples, the different users registered to instant messaging system 300 are stored in user database 310. This user database provides information needed to search for and find other users as well as contact users when they are online.

The different aspects of the present invention may be implemented within the components in instant messaging system 300. In particular, the different instant messaging clients may contain the processes necessary to create messages that will self-destruct after a selected amount of time. The message self-destructs when the message should no longer be read by the recipient of the message.

The self-destruction of a message may include, for example, the deletion of the message from the message store of the instant messaging client for the user. Alternatively, the self-destruction of a message may involve scrambling or encoding the message. Each client also includes processes for handling received messages that should be self-destructed. In the event that messages are handled or stored on instant messaging server 308, instant messaging server 308 may contain processes to provide for the self-destruction of messages on the different clients.

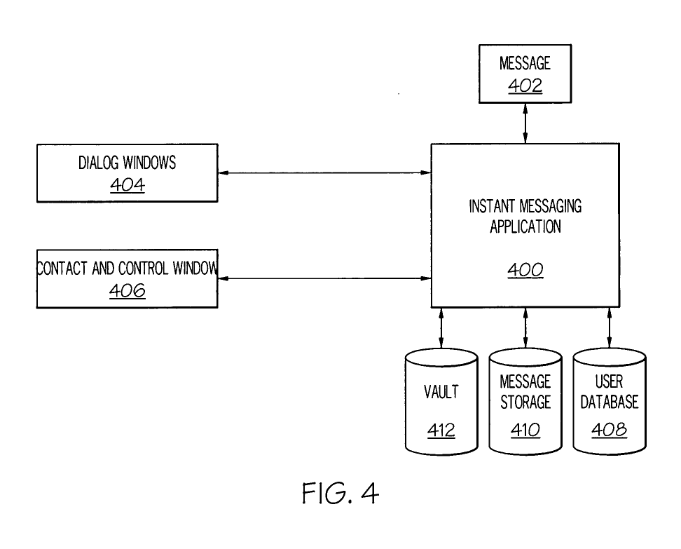

Turning next to FIG. 4, a diagram illustrating an instant messaging client is depicted in accordance with a preferred embodiment of the present invention. The components illustrated in FIG. 4 may be found in an instant messaging client, such as instant messaging client 401, 402, or 403 in FIG. 4. These components may be implemented in a data processing system, such as data processing system 200 in FIG. 2.

In the illustrative example, instant messaging application 400 processes messages, such as message 402, received from users located on remote data processing systems. As messages are received, these messages are presented in dialog windows 404. Additionally, dialog windows 404 provide an interface for a user to input text to send messages to other users.

Contact and control window 406 is presented by instant messaging application 400 to provide the user with a list of user names, as well as other information. Contact and control window 406 also provides an interface to allow a user to set different preferences. For example, the user may set passwords required to access different names used in instant messaging sessions.

Also, a user may employ contact and control window 406 to set other preferences, such as colors and fonts used in instant messaging application 400. These preferences also may include whether a picture is to be sent when a session is initiated with another user. Depending on the implementation, the preference may be set to allow a user who receives messages to retrieve images of the senders from a remote database or a local cache.

Further, a list of names presented by contact and control window 406 are stored in contact list 408 in these examples. Additional user or screen names may be added to or deleted from contact list 408. This contact list is employed in presenting the list of names within contact and control window 406.

In the illustrative examples, instant messaging application 400 includes processes to create and handle messages that are to be self-destructed. For example, instant messaging application 400 includes message store 410 into vault 412. Message store 410 is typically used to store messages received during a chat session or message exchange between users.

Instant messaging application 400 identifies messages that have been marked for self-destruction after a selected period of time. After the selected period of time for a message is reached, that message in message store 410 is self-destructed. As a result, the user is unable to view that particular message. As previously mentioned, the self-destruction of a message may involve, for example, deletion of the message from message store 410. Alternatively, the message in message store 410 may be encrypted. Additionally, if a message has been scrambled or encrypted, the message may be then unencrypted through the use of an appropriate password or key by the user.

Further, instant messaging application 400 may display sensitive messages that are marked for self-destruction in the context of a chat session. Alternatively, a sensitive message that is marked for self-destruction may be displayed in a separate window within dialog windows 404 outside of the confines of the standard or typical chat window. In either instance, the user may indicate the length of the time that the recipient may view a message either “on the fly” or as part of a preference setting through contact in control window 406 in these examples. Further, both of these different examples used to display sensitive messages may allow the user the option to display or not display a self-destruct countdown with the message. This option may be set as a preference or at the time the message is sent.

A user may retrieve or reconstruct a self-destructed message in these examples. Such a feature is useful when a user may be away from the client application when the message has been received. In the illustrative examples, the recipient may obtain or reconstruct a self-destructed message by accessing a secure file buffer, such as vault 412, containing the self-destructed messages from the sender. In these examples, vault 412 is password protected. Alternatively, the user may use a password to unscramble a scrambled version or encrypted version of the self-destructed message displayed in the chat window. Additionally, a separate chat session or dialog may be employed through which the sensitive information is redisplayed then re-self-destructed in the manner originally designated. The second chat session allows the user to replay the messages that the user may have missed or wish to review again.

Further, the different aspects of the present invention allow recipient to be prompted to retrieve the message if the recipient has not responded to that message within the self-destruct time limit. Alternatively, the user may retrieve messages by issuing a command through contact and control window 406 to instant messaging application 400. This retrieval of self-destructed messages also may be initiated by selecting or clicking on a status information message displayed in dialog windows 404. For example, a status information message “the message has self-destructed” may replace the self-destructed message. By selecting the status message, the retrieval or reconstruction of self-destructed messages may occur. An example of another mechanism by which the retrieval may occur is through selecting the scrambled or encrypted version of the message on the chat window.

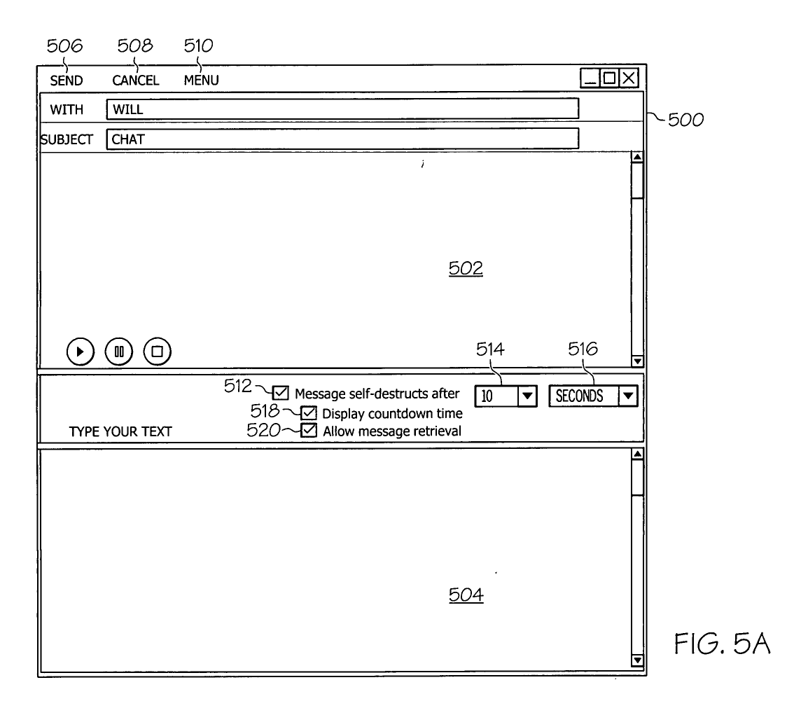

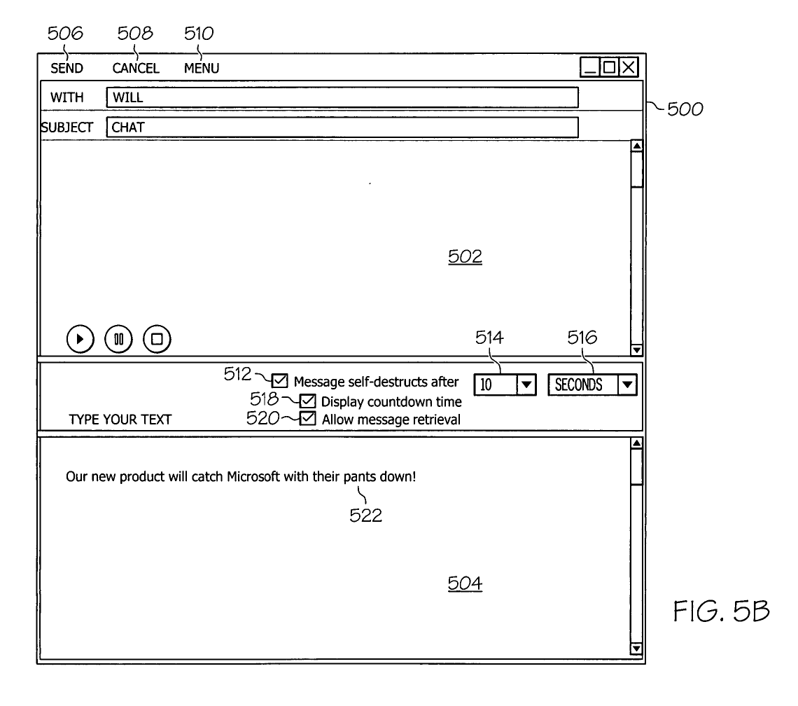

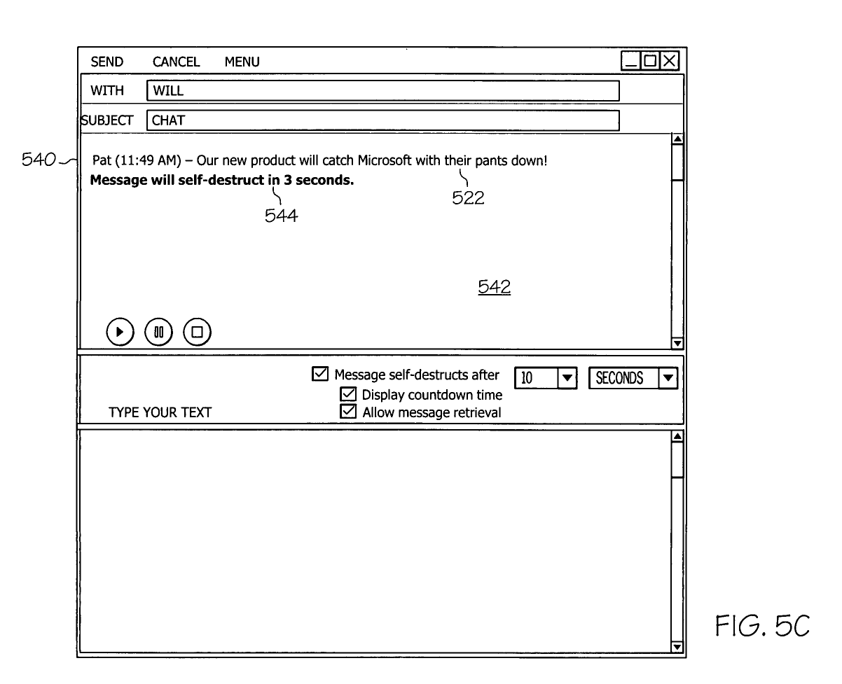

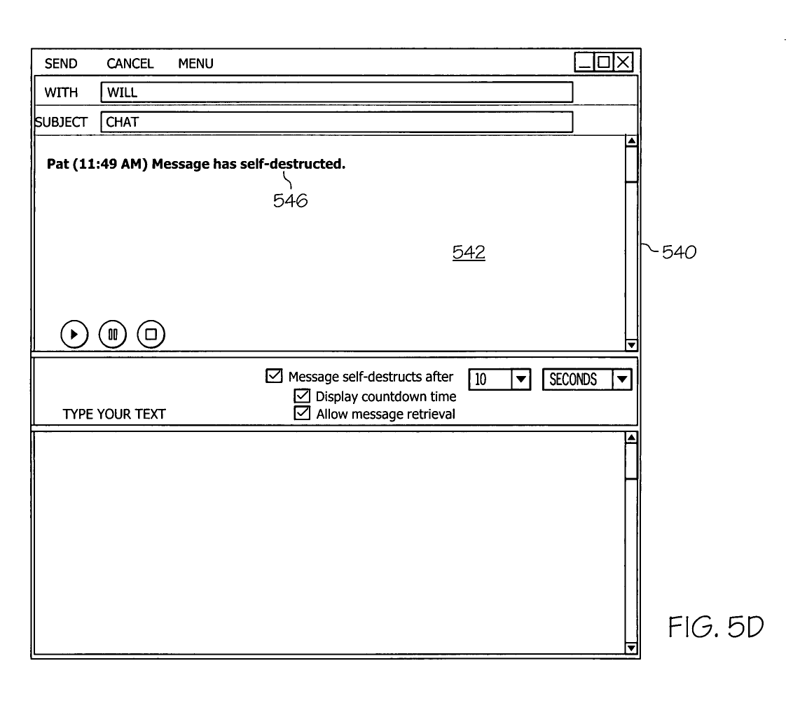

Turning now to FIGS. 5A-5D, diagrams illustrating chat windows are depicted in accordance with illustrative embodiments of the present invention. In FIG. 5A, chat window 500 is an example of a dialog window that may be displayed by an instant messaging application, such as instant messaging application 400 in FIG. 4. In particular, chat window 500 is an example of a dialog window within dialog windows 404 in FIG. 4. In this example, chat window 500 displays messages in a chat session within section 502. A user may generate messages to send to a recipient in section 504 of chat window 500. Messages are sent using send button 506 commands may be cancelled through cancel button 508. Menu button 510 is used to bring up other options for the chat session.

In these illustrative examples, a self-destruct message may be indicated by selecting check box 512. The time after which a message will self-destruct may be selected by user through controls 514 and 516. Control 514 is used to select a numerical value. In this example, the numerical value is 10. Control 516 is used to select the type of time period. In these examples, the time period is in seconds. As a result, the message will self-destruct-after ten seconds if check box 512 is selected. Check box 518 is used to set a preference as to whether a countdown timer will be displayed in association with a message that is to be self-destructed. Check box 520 is used to select a preference as to whether a message may be retrieved or reconstructed at a later time.

In this example in FIG. 5A, chat window 500 shows the state before a message is sent from a sender to a recipient. With the different controls illustrated in chat window 500, a user may specify whether the message should be self-destructed and how long a self-destructed message should be viewable. Additionally, whether the countdown timer should be displayed and if the message may be retrieved by the recipient may be specified. The particular user interface in chat window 500 allows a user to specify these different options for each message being sent in the context of the chat session.

In FIG. 5B, check box 512 is selected indicating that a self-destruct mode has been activated for message 522 that has been entered in section 504. By selecting check box 512, the other options or preferences in check box 520 are enabled. In this example, the message self-destructs after ten seconds and a countdown timer is displayed with the message that is sent as well as allowing the user to retrieve the message at a later time.

Next, in FIG. 5C, chat window 540 is a chat window for the recipient of the message typed by the user in chat window 500. Chat window 540 displays message 522 in section 542 in this illustrative example. Additionally, a countdown timer 544 is displayed within the chat session in section 542. In this example, seven seconds have elapsed since the message has been sent and displayed in chat window 540.

Turning to FIG. 5D, the message in chat window 540 has self-destructed. The self-destruction is shown by status message 546. As can be seen, message 522 in section 502 has been replaced with status message 546 in FIG. 5D. This status message indicates that the prior message has message 522 self-destructed. In these examples, by selecting check box 512 in FIG. 5A, all messages sent using send button 506 are sent as self-destructing messages. The messages are sent as self-destructing messages until the user unchecks check box 512.

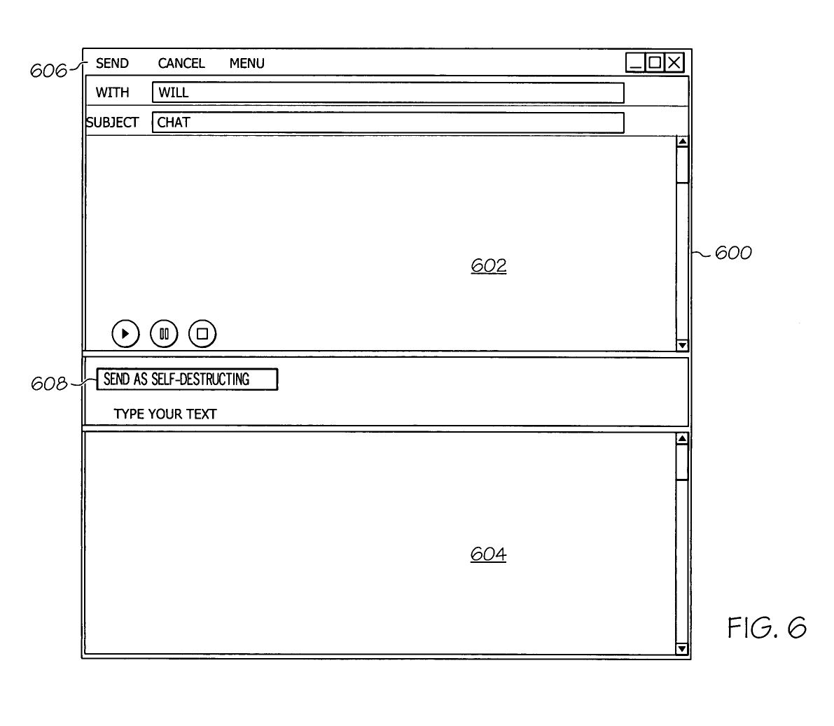

Turning now to FIG. 6, an illustration of a chat window is depicted in accordance with an illustrative embodiment of the present invention. In this example, chat window 600 contains section 602 in which chat messages for a user are displayed. Section 604 is an area in which messages are created and sent. In this example, check boxes such as those illustrated in FIGS. 5A-5D are not employed. Instead, the user, in this example, is required to select or manipulate a separate control from send button 606 to send the message as a self-destructing message. In this example, the user selects button 608 to send the message as a self-destructing message. As a result, this type of selection must be made each time a user desires to send message as self-destructing.

This example is in contrast to those shown in FIGS. 5A-5D in which each message sent after a check box has been selected is sent as a self-destructing message without requiring additional input. Additionally, preferences as to the time to self-destruct, a countdown timer, and retrieval permission are not shown in chat window 600. In these examples, the preferences may be set in a separate dialog, although they may appear within the context of chat window 600 in association with button 608.

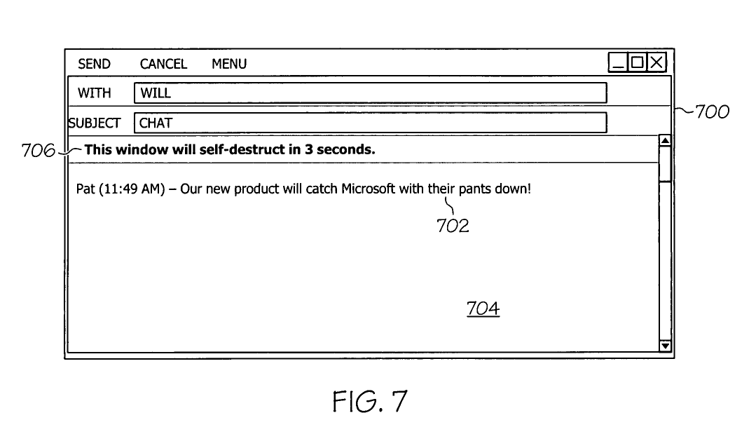

In FIG. 7, a diagram illustrating an alternative example of a sent message is depicted in accordance with an illustrative embodiment of the present invention. In this example, dialog 700 is used to present self-destructing message 702 within section 704 in dialog 700. A timer also is displayed in section 706 of dialog 700. Dialog 700 is displayed as a dialog outside of the chat window when used to display messages. This example, the chat window is used to display unsecured messages. Dialog 700 may be removed once the viewing time has elapsed depending upon the particular implementation. This type of display of the message may function either with a check box or separate send button for specifying the type of display for a self-destructing message.

Turning next to FIG. 8, a diagram illustrating a dialog used to retrieve self-destructed messages as depicted in accordance with an illustrative embodiment of the present invention. In this particular example, dialog 800 is a prompt for a recipient to retrieve self-destructed messages. Dialog 800 indicates that the user has received one or more messages from a sender that have self-destructed without an acknowledgment of those messages by the user. Dialog 800 provides field 802 for the user to enter a password to retrieve messages from a buffer, such as vault 412 in FIG. 4. Once the password has been entered in field 802, the user may select okay button 804 to retrieve messages or the user may cancel the process by select cancel button 806. Depending upon the implementation, dialog 800 also may include a status window to indicate the number of self-destructed messages that await retrieval.

Alternatively, instead of using dialog window 800, the user may select the status message indicating the message has been self-destructed. For example, the user may select status message 546 in FIG. 5D to initiate the display of a dialog similar to dialog 800.

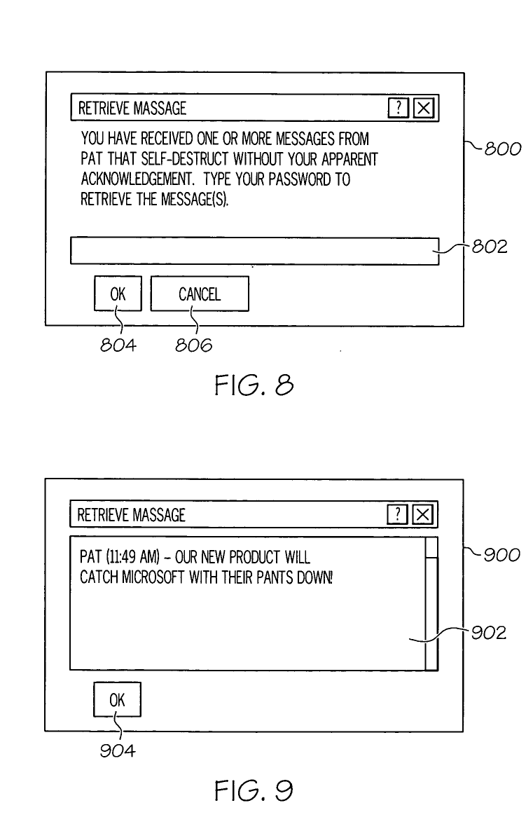

With reference to FIG. 9, a diagram illustrating a dialog for retrieving self-destructed messages is depicted in accordance with an illustrative embodiment of the present invention. In this example, dialog 900 is displayed to the user when the user requests retrieval of self-destructed messages. This dialog displays self-destructed messages within section 902. When the user is done viewing the self-destructed message, the user selects okay button 904 to close dialog 900.

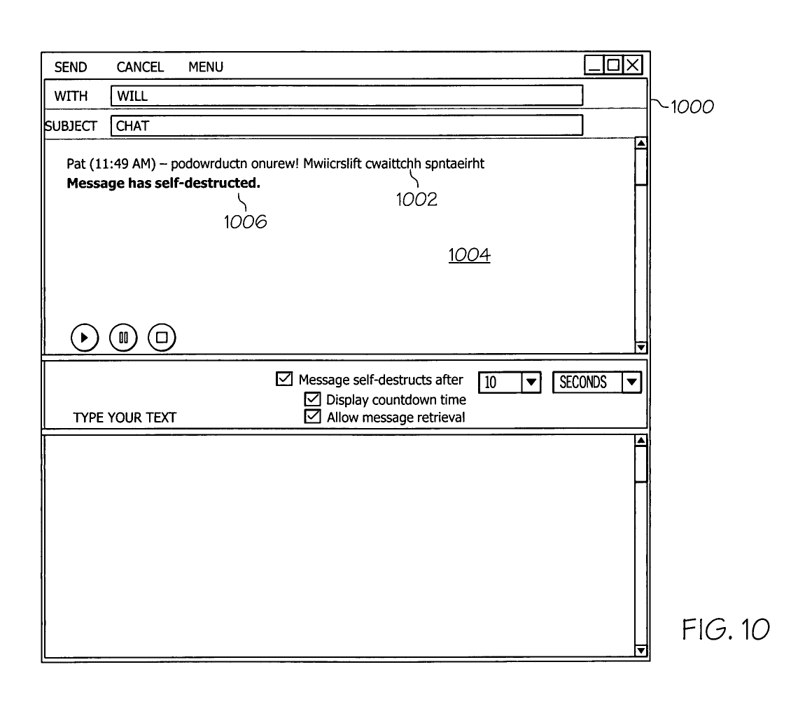

Turning to FIG. 10, a diagram illustrating a window used for retrieving self-destructed messages is depicted in accordance with an illustrative embodiment of the present invention. In this example, chat window 1000 shows a self-destructed message as encrypted message 1002. This message is identified as being self-destructed through status message 1004. The user may select encrypted message 1002 to initiate the display of a dialog, such as dialog 800 in FIG. 8, to retrieve messages for viewing. When the message is retrieved, encrypted message 1002 is replaced with the original message within section 1004. The message is re-encrypted or re-scrambled after the self-destruct period has again elapsed in these examples.

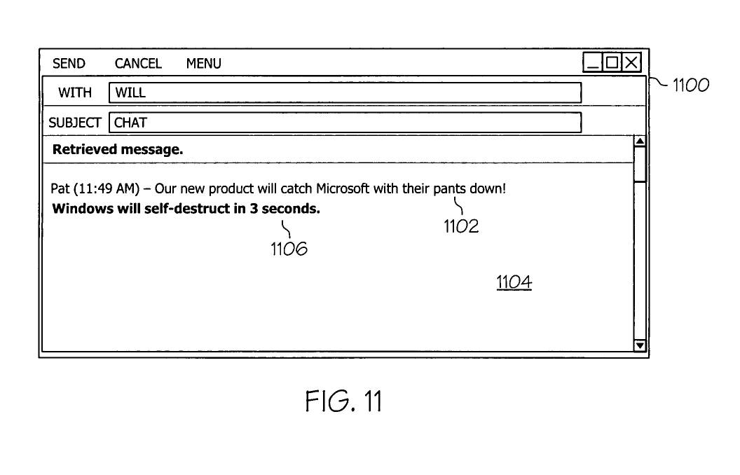

Turning now to FIG. 11, a diagram illustrating a window used to retrieve self-destructed messages as depicted in accordance with an illustrative embodiment of the present invention. In this example, window 1100 is displayed to the user after the user authenticates or enters the correct password. This password may be entered using a dialog, such as dialog 800 of FIG. 8. Window 1100 is displayed with message 1102 in section 1104. Timer 1106 also is depicted in window 1100 to indicate when the message will again self-destruct.

As can be seen from FIGS. 5A-11, messages sent through an instant messaging system may be secured through a self-destruct and retrieval mechanism as shown in the different examples. In self-destructing messages, these examples show that these types of messages may be removed from the chat window, scrambled or encrypted within the chat window, or sent to a second window that is no longer displayed after the time-out or self-destruct period. Retrieval or access to these messages, if allowed by the sender, may be performed in the examples through a dialog notification, a command in the instant message application, or by selecting on the self-destruct status information message, or the encrypted message itself period. In these illustrative examples, all the retrieval mechanisms require a password to retrieve the message.

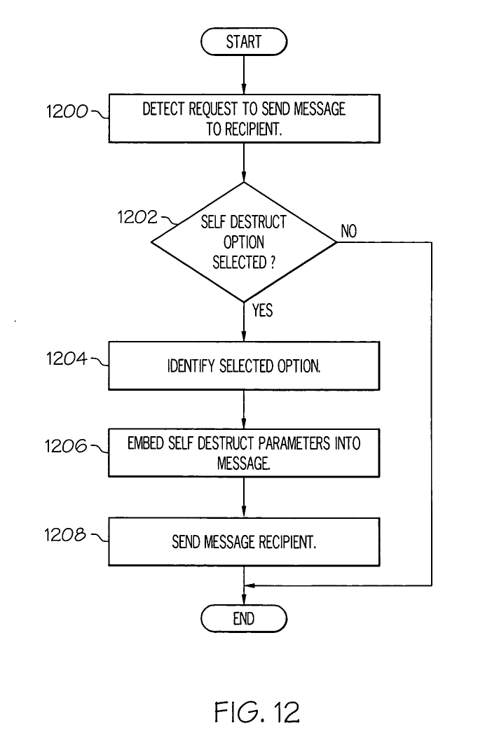

In FIG. 12, a flowchart of a process for sending a self-destructing message is depicted in accordance with an illustrative embodiment of the present invention. The process begins by detecting a request to send a message to a recipient (step 1200). A determination is made as to whether a self-destruct option has been selected (step 1202).

The process illustrated in FIG. 12 may be implemented in an instant messaging application, such as instant messaging application 400 in FIG. 4.

The self-destruct option may be selected in a number of different ways. For example, a check box for the option may be selected, such as check box 512 in FIG. 5A. Alternatively, a separate button or control, such as button 600 in FIG. 6 may be selected to indicate that the self-destruct option is present. If the self-destruct option has been selected, selected options are identified (step 1204). These options include, for example, the amount of time a message will be displayed until it self-destructs, whether a countdown timer is to be displayed in association with the message and whether a recipient is allowed to retrieve self-destructed messages. These parameters are embedded into the message (step 1206). The message is then sent to the recipient (step 1208), with the process terminating thereafter. With reference again to step 1202, if the self-destruct option has not been selected, the message proceeds to (step 1208) to be sent to a recipient.

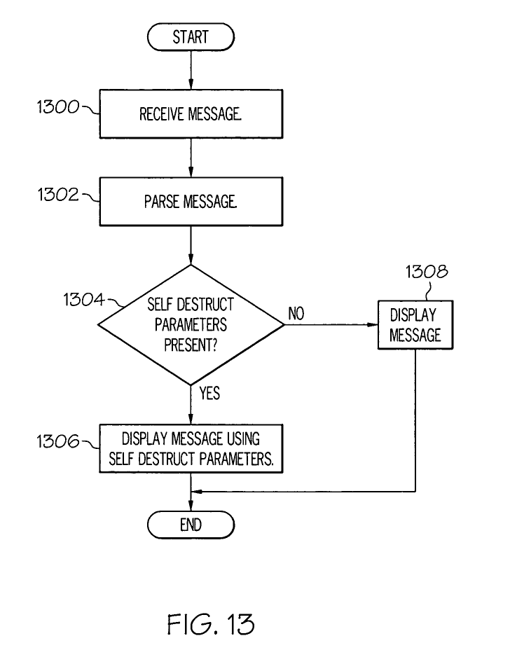

Turning to FIG. 13, a flowchart of the process for handling messages are depicted in accordance with an illustrative embodiment of the present invention. The process illustrated in FIG. 13 may be implemented in an instant messaging application, such as instant messaging application 400 in FIG. 4.

The process begins by receiving a message (step 1300). The message is then parsed (step 1302). A determination is made as to whether self-destruct parameters are present in the parsed message (step 1304). If self-destruct parameters are present, the message is displayed using the self-destruct parameters (step 1306), with the process terminating thereafter. In step 1304, if the self-destruct parameters are absent in the message, the message is displayed normally step (1308), with the process terminating thereafter. In step 1306, the display the message using self-destruct parameters vary depending upon the particular implementation.

The different illustrations in FIGS. 5A-11 show how messages may be displayed using the different self-destruct parameters. For example, a timer may be displayed within the section of the chat window in which the message is presented, such as in FIG. 5C where the display of this type of message in a totally separate dialog, such as illustrated in FIG. 7 may be used.

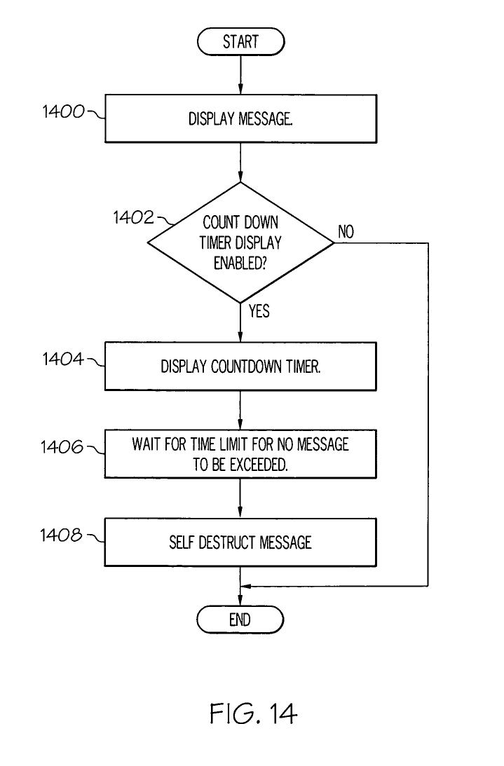

Turning now to FIG. 14, a flowchart illustrating a process for displaying a self-destructing message is depicted in accordance with an illustrative embodiment of the present invention. The process illustrated in FIG. 13 may be implemented in an instant messaging application, such as instant messaging application 400 in FIG. 4.

The process begins by displaying the receiving the displayed message in (step 1400). A determination is made as to whether a countdown timer display has been enabled (step 1402). If a countdown timer has been enabled, the process displays the countdown timer (step 1404). This countdown timer may be displayed in the section of the chat window in which the message is presented. Alternatively, this countdown may be displayed in other portions of the chat window or in a separate dialog depending upon the particular implementation.

The process then waits for the time limit for the message to elapse (step 1406). Once the time limit has been exceeded, the process self-destructs the message (step 1408), with the process terminating thereafter. Self-destruction of the message may include, for example, removal of the message from the chat window. The self-destruction also may include scrambling or encrypting the message within the chat window. If a message is removed or encrypted, a status message also may be presented to the user indicating that the message has self-destructed.

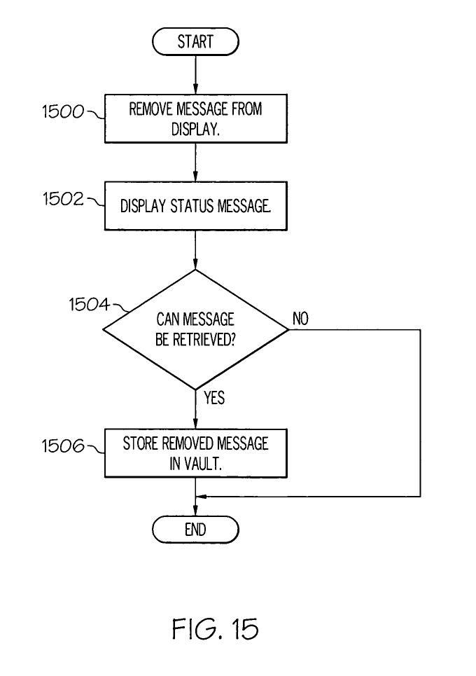

Turning now to FIG. 15, a flowchart of a process for self-destructing a message is depicted in accordance with an illustrative embodiment of the present invention. The process illustrated in FIG. 15 may be implemented in an instant messaging application, such as instant messaging application 400 in FIG. 4.

The process begins by removing the message from display (step 1500). Thereafter, a status message is displayed (step 1502). A determination is made as to whether the message can be retrieved or reconstructed at a later time (step 1504). This determination in step 1504 is performed by examining parameter that indicates whether a message can be retrieved at a later time. Additionally, this step may include determining whether a reply to the message has been made. Messages without replies may be saved for later retrieval in case the recipient had not read the messages. If the message can be retrieved, the message is stored in a vault (step 1506), with the process terminating thereafter. This vault is, for example, vault 412 in FIG. 4.

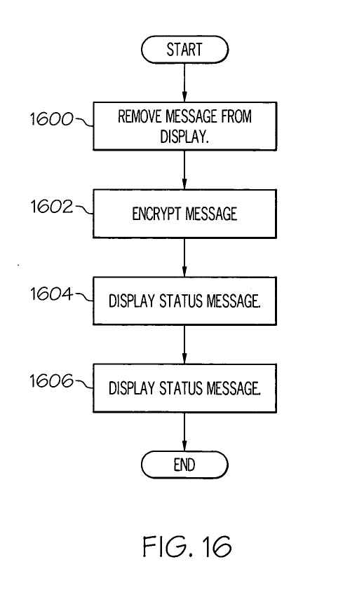

Turning now to FIG. 16, a flow chart of a process for self-destructing a message is depicted in accordance with an illustrative embodiment of the present invention. The process illustrated in FIG. 16 may be implemented in an instant messaging application, such as instant messaging application 400 in FIG. 4. In this particular example, the message is encrypted, rather than removed and stored in a vault as described above for the process in FIG. 15.

The process begins by removing the message from the display (step 1600). Thereafter, the message is encrypted (step 1602). Thereafter, the encrypted form of the message is displayed (step 1604), and a status message is displayed (step 1606) with the process terminating thereafter.

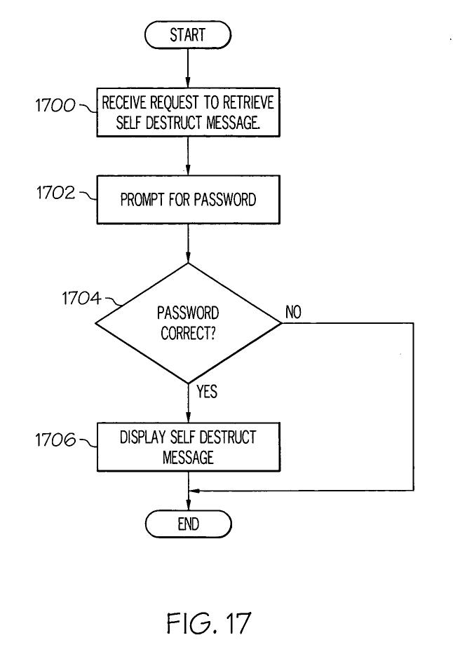

With reference to FIG. 17, a flowchart of a process for retrieving or reconstructing a self-destructed message is depicted in accordance with an illustrative embodiment of the present invention. The process illustrated in FIG. 17 may be implemented in an instant messaging application, such as instant messaging application 400 in FIG. 4.

The process begins by receiving a request to retrieve a self-destructed message (step 1700). This request may be received in a number of different ways depending upon the particular implementation. For example, the user may select the status message or an encrypted form of the message in a chat window. Additionally, the user may select the command from a menu to initiate the retrieval or a dialog may be displayed to the user when the user has not responded to one or more self-destructed messages as illustrated in FIG. 8.

The process then prompts the user for a password (step 1702). A determination is made as to whether the password is correct (step 1704). If the password is correct, the self-destructed message is displayed to the user (step 1706), with the process terminating thereafter. Otherwise, the process terminates without displaying the self-destructed message. The display of the self-destructed message may be performed using a number of different mechanisms. For example, the message may be displayed in the chat window or in a separate dialog from the chat window.

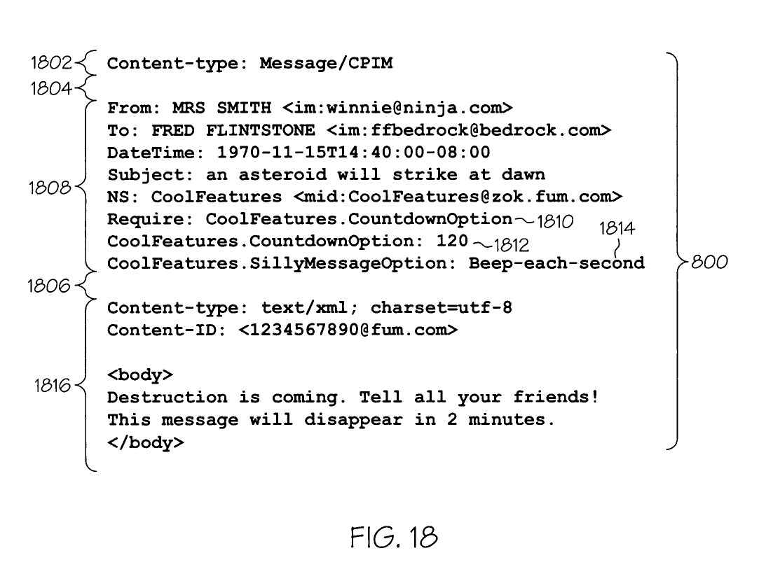

Turning next to FIG. 18, a diagram illustrating how options for handling a message may be included in an instant message is depicted in accordance with an illustrative example. In this example, message 1800 contains a two minute countdown timer. Of course, any other option may be implemented in the same fashion as shown in this diagram. Section 1802 is a multi-purpose Internet mail extension (MIME) header. Section 1804 and 1806 are separators within message 1800. Section 1808 depicts a message header in which the two minute countdown timer is designated. In particular, lines 1810, 1812, and 1814 within section 1808 identify and describe the countdown timer. Line 1810 is the portion of the header indicating to the receiver that option my features countdown option must be supported. Line 1812 identifies the length of the countdown timer, and line 1814 indicates that an alert should be provided each second during the countdown. Section 1816 illustrates the body of the message containing the text that is displayed to the user.

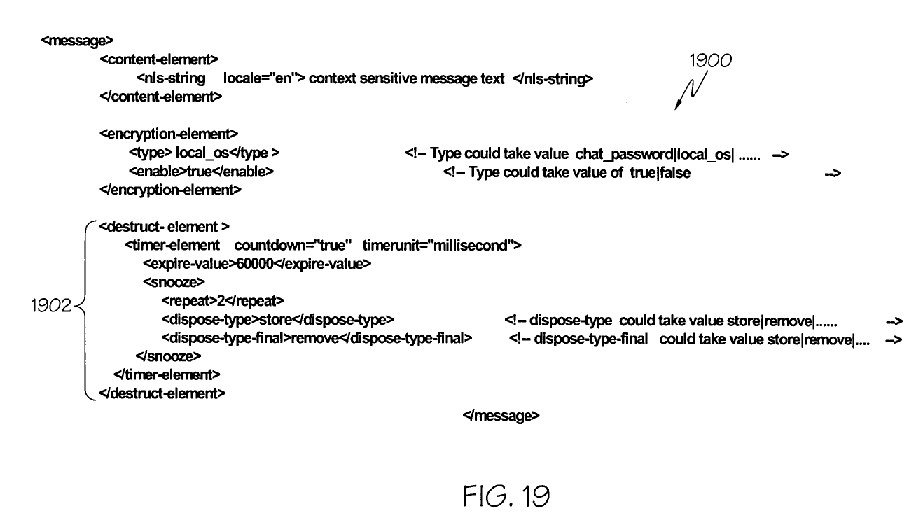

With reference to FIG. 19, another example as to how options may be included in a message is depicted in accordance with an illustrative example. Message 1900 illustrates tags or message being sent to a target recipient. In this example, section 1902 identifies that a countdown timer is to be used to self destruct the message.

The examples illustrated in FIG. 18 and 19 are presented as examples as to how options may be imbedded in an instant message to identify when and how a message may be self destructed using the processes described above. These examples are for purposes of illustration and are not intended to limit the manner of which the objects may be designated within a message.

The aspects of the present invention provide a computer implemented method, apparatus, and computer usable code for securing and retrieving instant messages. The different aspects illustrated in the examples self-destruct the message after a selected amount of time. The self-destruction of a message reduces the possibility that an unauthorized observer may see a message that is presented on a chat window while the user is away. The different aspects of the present invention also allow a user to retrieve messages to view again at a later time. This feature is useful if the user has never seen the message or needs to see the message again after the message has self-destructed.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing instant messages, the computer implemented method comprising:
receiving an instant message at a client;
identifying a set of parameters in the instant message;
presenting the instant message on a display in the client; and
removing the instant message from the display after a period of time defined by the set of parameters.

2. The computer implemented method of claim 1 further comprising:
displaying an amount of time remaining before the instant message is removed from the display.

3. The computer implemented method of claim 1, wherein the removing step comprises:
replacing the instant message with a status message.

4. The computer implemented method of claim 1 further comprising:
identifying the instant message as being a secure instant message; and
displaying the secure instant message in a separate window from unsecured instant messages in a chat session.

5. The computer implemented method of claim 1 further comprising:
responsive to the period of time passing, determining whether the instant message is retrievable using the set of parameters;
responsive to the instant message being a retrievable instant message, storing the retrievable instant message for retrieval.

6. The computer implemented method of claim 5 further comprising:
responsive to a user input to redisplay the retrievable instant message, requesting a correct password; and
responsive to receiving the correct password, displaying the retrievable instant message.

7. The computer implemented method of claim 6, wherein the retrievable instant message is displayed using the set of parameters.

8. The computer implemented method of claim 6, wherein the storing step comprises:
encrypting the retrievable instant message to form an encrypted message; and
storing the encrypted message.

9. The computer implemented method of claim 6, wherein the removing step comprises:
displaying the encrypted instant message.

10. The computer implemented method of claim 8 further comprising:
responsive to a user input to redisplay the encrypted instant message, requesting a correct password; and
responsive to receiving the correct password, unencrypting the encrypted instant message to form an unencrypted instant message; and
displaying the unencrypted instant message

11. The computer implemented method of claim 1 further comprising:
responsive to a user input to secure the instant message, placing the set of parameters in the instant message; and
sending the instant message to the client for display using the set of parameters.

12. A computer program product comprising:
A computer usable medium having computer usable program code for managing instant messages, the computer program product including:
computer usable program code for receiving an instant message at a client;
computer usable program code for identifying a set of parameters in the instant message;
computer usable program code for presenting the instant message on a display in the client; and
computer usable program code for removing the instant message from the display after a period of time defined by the set of parameters.

13. The computer program product of claim 12 further comprising:
computer usable program code for displaying an amount of time remaining before the instant message is removed from the display.

14. The computer program product of claim 12, wherein the computer usable program code for removing the instant message from the display after a period of time defined by the set of parameters comprises:
computer usable program code for replacing the instant message with a status message.

15. The computer program product of claim 12 further comprising:
computer usable program code for identifying the instant message as being a secure instant message; and
computer usable program code for displaying the secure instant message in a separate window from unsecured instant messages in a chat session.

16. The computer program product of claim 12 further comprising:
computer usable program code, responsive to the period of time passing, for determining whether the instant message is retrievable using the set of parameters;
computer usable program code, responsive to the instant message being a retrievable instant message, for storing the retrievable instant message for retrieval.

17. The computer program product of claim 16 further comprising:
computer usable program code, responsive to a user input to redisplay the retrievable instant message, for requesting a correct password; and
computer usable program code, responsive to receiving the correct password, for displaying the retrievable instant message.

18. The computer program product of claim 17, wherein the retrievable instant message is displayed using the set of parameters.

19. The computer program product of claim 16, wherein the computer usable program code, responsive to the instant message being a retrievable instant message, for storing the retrievable instant message for retrieval comprises:
computer usable program code for encrypting the retrievable instant message to form an encrypted message; and
computer usable program code for storing the encrypted message.

20. The computer program product of claim 17, wherein the computer usable program code for removing the instant message from the display after a period of time defined by the set of parameters comprises:
computer usable program code for displaying the encrypted instant message.

21. The computer program product of claim 19 further comprising:
computer usable program code, responsive to a user input to redisplay the encrypted instant message, for requesting a correct password; and
computer usable program code, responsive to receiving the correct password, for unencrypting the encrypted instant message to form an unencrypted instant message; and
computer usable program code for displaying the unencrypted instant message

22. The computer program product of claim 12 further comprising:
computer usable program code, responsive to a user input to secure the instant message, for placing the set of parameters in the instant message; and
computer usable program code for sending the instant message to the client for display using the set of parameters.

23. A data processing system comprising:
a bus;
a communications unit connected to the bus;
a memory connected to the bus, wherein the storage device includes a set of computer usable program code; and
a processor unit connected to the bus, wherein the processor unit executes the set of computer usable program code to manage instant messages; receive an instant message at a client; identify a set of parameters in the instant message; present the instant message on a display in the client; and remove the instant message from the display after a period of time defined by the set of parameters.

24. The data processing system of claim 23, wherein the processor unit further executes the computer usable program code to display an amount of time remaining before the instant message is removed from the display.

25. The data processing system of claim 23, wherein the processor unit further executes the computer usable program code to replace the instant message with a status message.

26. The data processing system of claim 23, wherein the processor unit further executes the computer usable program code to identify the instant message as being a secure instant message; and display the secure instant message in a separate window from unsecured instant messages in a chat session.

27. The data processing system of claim 23, wherein the processor unit further executes the computer usable program code to determine whether the instant message is retrievable using the set of parameters in response to the period of time passing; and store the retrievable instant message for retrieval in response to the instant message being a retrievable instant message.

28. The data processing system of claim 27, wherein the processor unit further executes the computer usable program code to request a correct password in response to a user input to redisplay the retrievable instant message; and display the retrievable instant message in response to receiving the correct password.

29. The data processing system of claim 28, wherein the processor unit further executes the computer usable program code encrypt the retrievable instant message to form an encrypted message; and store the encrypted message.
